(19) United States
(12) Patent Application Publication
(10) Pub. No.: US 2026/0213464 A1
(43) Pub. Date: Jul. 23, 2026

(54) CONNECTOR

(71) Applicant: SUMITOMO WIRING SYSTEMS, LTD., Mie (JP)

(72) Inventor: Kiyoshi OSAWA, Mie (JP)

(21) Appl. No.: 19/138,661

(22) PCT Filed: Dec. 1, 2023
(86) PCT No.: PCT/JP2023/043049

§ 371 Date: Jun. 13, 2025

(30) Foreign Application Priority Data
Dec. 19, 2022 (JP) 2022-202175

(51) Int. Cl. H01R 13/6581; H01R 13/52

(52) U.S. Cl. CPC H01R 13/6581; H01R 13/5205

(57) ABSTRACT

A connector is to be fixed to a plurality of wires each including a core wire and an insulation coating. The connector includes terminals to be connected to the core wires, resin housings for covering the core wires and the terminals, a metal shell for covering the resin housings, the metal shell being fixed to a metal case, and a metal bracket, to which a collective shield member for covering the insulation coatings is connected and which is connected to the metal shell. The metal shell includes an internally threaded portion, and the metal bracket includes a fastening hole. The connector includes a fastening screw for fixing the metal bracket to the metal shell by being passed through the fastening hole and threadably engaged with the internally threaded portion.

### TECHNICAL FIELD

The present disclosure relates to a connector.

### BACKGROUND

Conventionally, a connector to be fixed to end parts of a plurality of wires is provided with terminals to be connected to core wires of the wires, resin housings for partitioning and covering the terminals and a metal shell having an electromagnetic shielding function for covering the resin housing (see, for example, Patent Document 1 (FIG. 21 and the like). Further, this connector is provided with a metal bracket, to which a braided member for covering insulation coatings is connected and which is connected to the metal shell. The metal shell is fixed to a metal case or the like serving as an external ground member. In this connector, the braided member is electrically connected to the external ground member via the metal bracket and the metal shell.

### PRIOR ART DOCUMENT

### Patent Document

Patent Document 1: International Publication No. WO 2012/124801

### SUMMARY OF THE INVENTION

### Problems to be Solved

However, in the connector as described above, the metal shell and the metal bracket are fastened by a bolt passed therethrough and a nut held in the resin housing. Thus, the number of components has increased and a structure for holding the nut in the resin housing has been complicated.

The present disclosure aims to provide a connector enabling the simplification of a configuration.

### Means to Solve the Problem

The present disclosure is directed to a connector to be fixed to a plurality of wires each including a core wire and an insulation coating, the connector being provided with terminals to be connected to the core wires, resin housings for covering the core wires and the terminals, a metal shell for covering the resin housings, the metal shell being fixed to an external ground member, and a metal bracket, a shield member for covering the insulation coatings being connected to the metal bracket, the metal bracket being connected to the metal shell, the metal shell including an internally threaded portion, the metal bracket including a fastening hole, and the connector being provided with a fastening screw for fixing the metal bracket to the metal shell by being passed through the fastening hole and threadably engaged with the internally threaded portion.

### Effect of the Invention

According to the connector of the present disclosure, a configuration can be simplified.

### BRIEF DESCRIPTION OF THE DRAWINGS

FIG. 1 is a perspective view of a connector and a metal case in one embodiment.

FIG. 2 is an exploded perspective view of the connector in the embodiment.

FIG. 3 is an exploded perspective view of the connector in the embodiment.

FIG. 4 is a side view of the connector in the embodiment.

FIG. 5 is a section along 5 -5 in FIG. 4.

FIG. 6 is a section along 6 -6 in FIG. 5.

FIG. 7 is a partial exploded front view of the connector in the embodiment.

FIG. 8 is a partial front view of the connector in the embodiment.

### DETAILED DESCRIPTION TO EXECUTE THE INVENTION

### Description of Embodiments of Present Disclosure

First, embodiments of the present disclosure are listed and described.

[1] The connector of the present disclosure is to be fixed to a plurality of wires each including a core wire and an insulation coating, and provided with terminals to be connected to the core wires, resin housings for covering the core wires and the terminals, a metal shell for covering the resin housings, the metal shell being fixed to an external ground member, and a metal bracket, a shield member for covering the insulation coatings being connected to the metal bracket, the metal bracket being connected to the metal shell, the metal shell including an internally threaded portion, the metal bracket including a fastening hole, and the connector being provided with a fastening screw for fixing the metal bracket to the metal shell by being passed through the fastening hole and threadably engaged with the internally threaded portion.

According to this configuration, since the fastening screw is provided which fixes the metal bracket to the metal shell by being passed through the fastening hole of the metal bracket and threadably engaged with the internally threaded portion of the metal shell, the configuration can be simplified, for example, as compared to a fastening configuration by a nut and a bolt. That is, for example, in the configuration for fastening the metal bracket and the metal shell by the nut and the bolt while holding the nut in the resin housing, the number of components is increased by the nut and a structure for holding the nut is complicated. However, this can be avoided.

[2] In [1] described above, the shield member may be a tubular collective shield member for collectively covering a plurality of the insulation coatings, and the metal bracket may include a tube portion, the collective shield member being connected to the tube portion over an entire periphery, and a fastening portion extending from a part in a circumferential direction of the tube portion and provided with the fastening hole.

According to this configuration, since the shield member is the tubular collective shield member for collectively covering the plurality of insulation coating and the metal bracket includes the tube portion, the collective shield member being connected to the tube portion over the entire periphery, the collective shield member can be satisfactorily Connected to the Metal Bracket.

[3] In [2] described above, the metal bracket may include a circumferentially engaging portion engageable in the circumferential direction of the tube portion on a side opposite to the fastening portion in the circumferential direction, and the metal shell may include a circumferentially engaged portion to be engaged with the circumferentially engaging portion.

According to this configuration, since the metal bracket includes the circumferentially engaging portion engageable in the circumferential direction of the tube portion on the side opposite to the fastening portion in the circumferential direction and the metal shell includes the circumferentially engaged portion to be engaged with the circumferentially engaging portion, rattling with respect to the metal shell is satisfactorily suppressed. That is, since the tube portion is suppressed from rattling in the circumferential direction with respect to the metal shell at two positions on sides opposite to each other in the circumferential direction, the rattling of the metal bracket with respect to the metal shell is satisfactorily suppressed.

[4] In [3] described above, the metal bracket may include an extending portion extending along an axial direction from the tube portion, the circumferentially engaging portion may be a slit extending along the axial direction of the tube portion from a tip of the extending portion, and the circumferentially engaged portion may be a rib projecting from the metal shell, extending along the axial direction of the tube portion and to be fit into the slit.

According to this configuration, since the circumferentially engaging portion is the slit extending along the axial direction of the tube portion from the tip of the extending portion and the circumferentially engaged portion is the rib projecting from the metal shell and extending along the axial direction of the tube portion, rattling with respect to the metal shell is strongly suppressed. That is, since the slit and the rib are engaged in a long range along the axial direction of the tube portion, the rattling of the metal bracket with respect to the metal shell is strongly suppressed.

[5] In [4] described above, the metal shell may include a positioning wall to be butted against the tip of the extending portion.

According to this configuration, since the metal shell includes the positioning wall to be butted against the tip of the extending portion, the metal bracket can be satisfactorily positioned along the axial direction of the tube portion.

[6] In any one of [2] to [5] described above, the connector may be provided with a rubber plug for preventing liquid intrusion along the insulation coatings and a retainer for preventing detachment of the rubber plug by being locked to the metal shell, the retainer may include contacting tube portions projecting outward from the metal shell and configured to contact outer peripheries of the insulation coatings, and the tube portion may be arranged to cover the contacting tube portions.

According to this configuration, since the retainer includes the contacting tube portions projecting outward from the metal shell and configured to contact the outer peripheries of the insulation coatings, even if the wire vibrates outside the connector, the transmission of that vibration to the terminal inside the connector can be suppressed. Thus, for example, the rubbing and the like of the terminal are suppressed. Since the tube portion is arranged to cover the contacting tube portions, good shielding is also provided at the contacting tube portions.

### Details of Embodiment of Present Disclosure

A specific example of a connector of the present disclosure is described below with reference to the drawings. For the convenience of description, some components may be shown in an exaggerated or simplified manner in each drawing. Further, a dimension ratio of each part may be different in each drawing. “Parallel”, “orthogonal” and “true circular” in this specification mean not only strictly parallel, orthogonal and true circular, but also substantially parallel, orthogonal and true circular within a range in which functions and effects in an embodiment are achieved. Note that the present invention is not limited to these illustrations, but is represented by claims and intended to include all changes in the scope of claims and in the meaning and scope of equivalents.

### Configuration of Connector 11

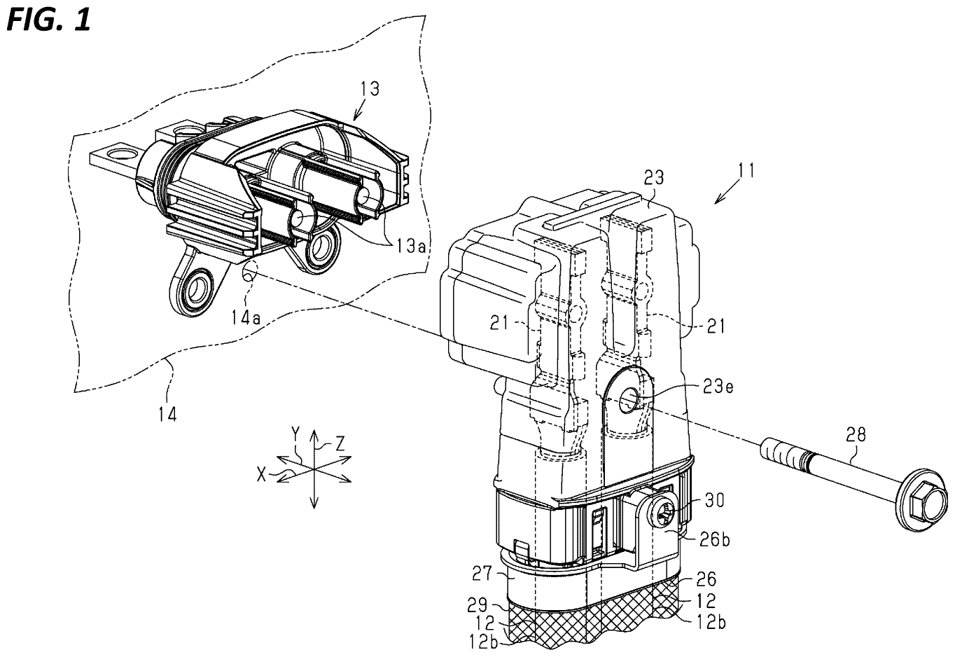

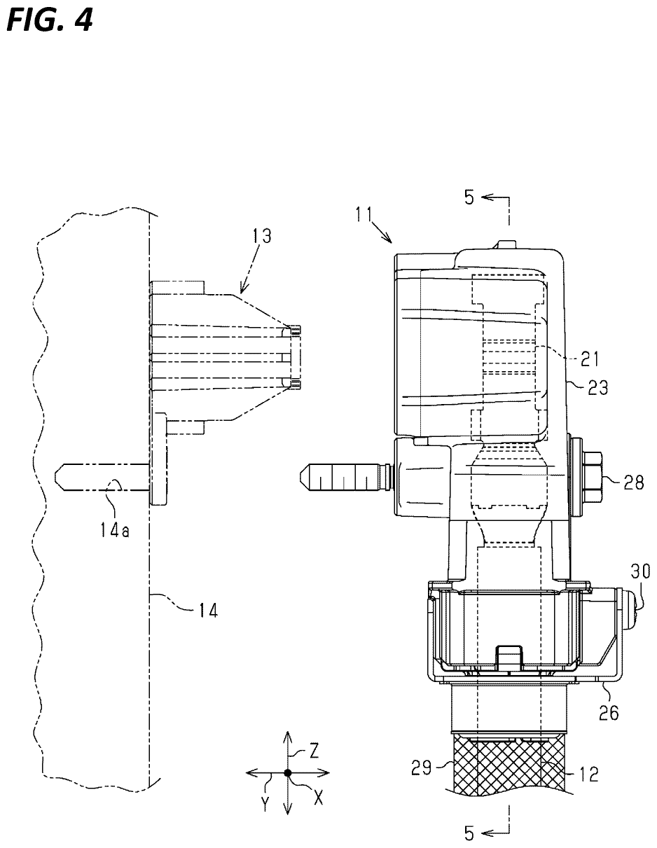

As shown in FIGS. 1 and 4, a connector 11 is to be fixed to end parts of a plurality of wires 12, connected to a mating connector 13 and fixed to a metal case 14 serving as an external ground member. Note that the connector 11 of this embodiment is fixed to end parts of two wires 12.

Further, a first axis X, a second axis Y orthogonal to the first axis X and a third axis Z orthogonal to the first and second axes X, Y are shown in figures. In this embodiment, a direction along the first axis X is described as a width direction, a direction along the second axis Y is described as a front-rear direction and a direction along the third axis Z is described as an axial direction.

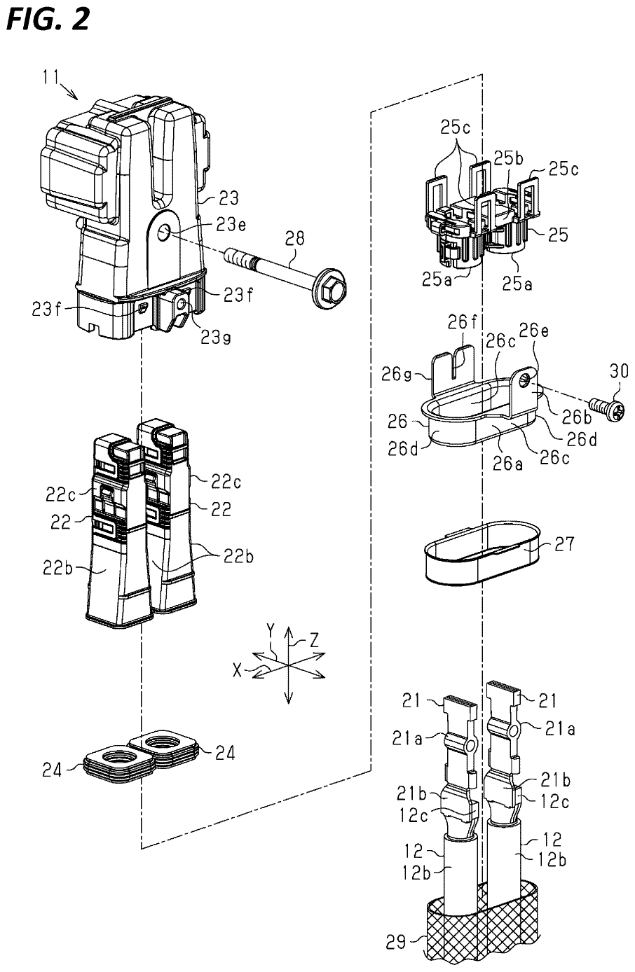

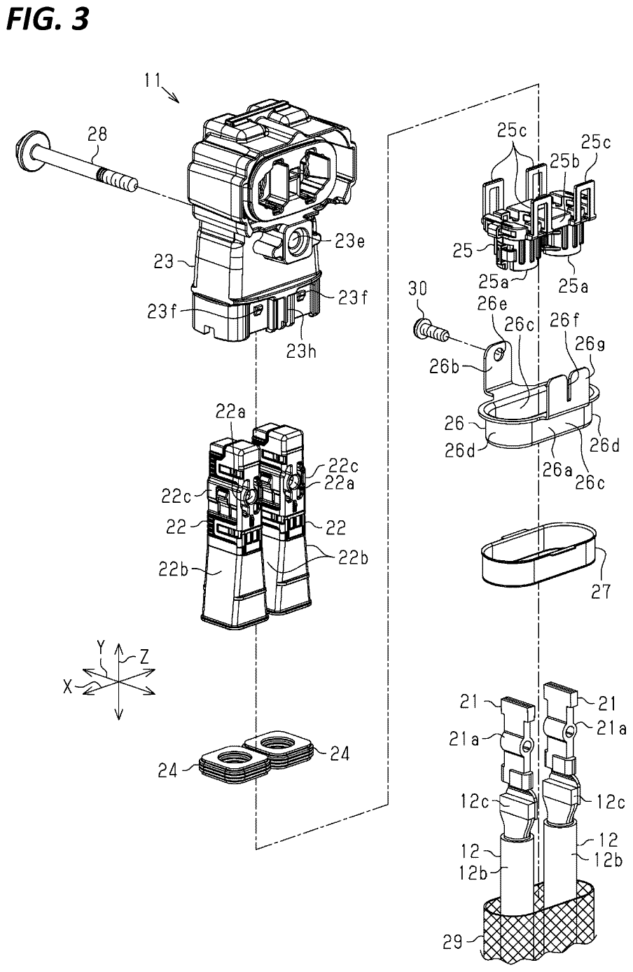

As shown in FIGS. 2 and 3, the connector 11 is provided with terminals 21, resin housings 22, a metal shell 23, rubber plugs 24, a retainer 25, a metal bracket 26 and a crimp ring 27. Two terminals 21, two resin housings 22 and two rubber plugs 24 are provided to correspond to the number of the wires 12.

(onfiguration of Terminals 21)

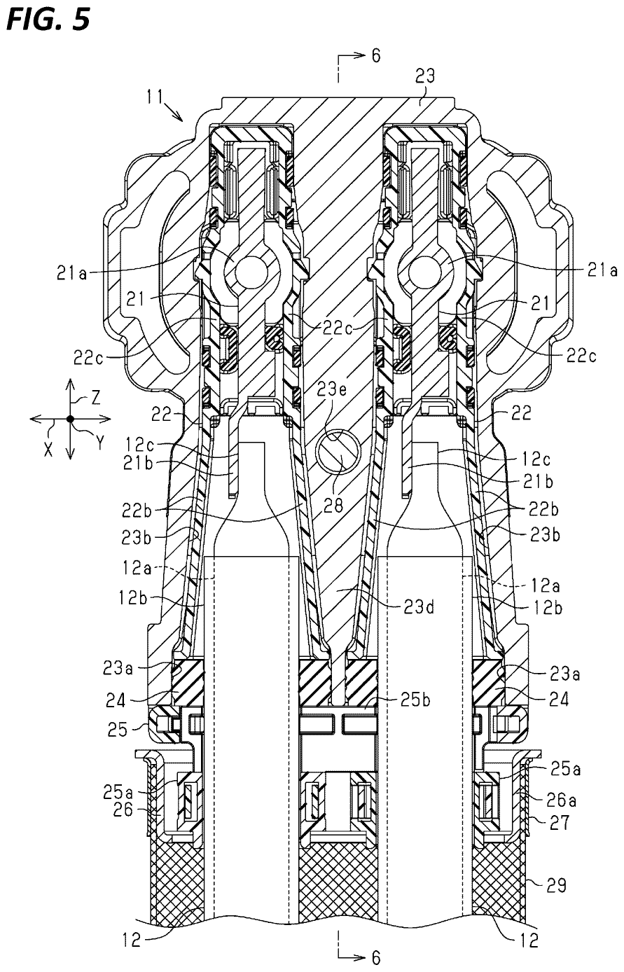

As shown in FIG. 5, the wire 12 includes a core wire 12a and an insulation coating 12b. The terminal 21 is connected to an end part of the core wire 12a exposed from the insulation coating 12b.

In particular, the core wire 12a includes a flat connecting portion 12c exposed from the insulation coating 12b and shaped to be flatter than the inside of the insulation coating 12b. That is, the flat connecting portion 12c is smaller than a diameter of the core wire 12a inside the insulation coating 12b in a thickness direction, which is a flat direction. The plurality of wires 12 are so arranged that the thickness direction of the flat connecting portions 12c is along the width direction, which is an arrangement direction of the plurality of wires 12. The terminal 21 includes a terminal fitting portion 21a fittable to a mating terminal 13a (see FIG. 1) of the mating connector 13 and a plate-like terminal connecting portion 21b to be connected to the flat connecting portion 12c. Note that, although the terminal 21 is formed by bending a metal plate material, the terminal 21 is schematically shown in figures without showing the details thereof. The terminal connecting portion 21b of the terminal 21 is overlapped on the flat connecting portion 12c in a plate thickness direction and fixed to the flat connecting portion 12c by welding. Note that, in this embodiment, the flat connecting portion 12c is formed into a flat shape by being squeezed in a state in contact with the terminal connecting portion 21b, and resistance-welded to the terminal connecting portion 21b in that state.

### (Configuration of Resin Housing 22)

As shown in FIGS. 2, 3 and 5, the resin housing 22 is formed into a tubular shape to cover the exposed core wire 12a, i.e. the flat connecting portion 12c, and the terminal 21. As shown in FIG. 3, the resin housing 22 includes a terminal opening 22a, which is open forward at a position corresponding to the terminal fitting portion 21a and through which the mating terminal 13a (see FIG. 1) is insertable.

Further, as shown in FIG. 5, the resin housing 22 includes a pair of narrowed wall portions 22b having an interval in the width direction gradually reduced in a direction toward the tip of the core wire 12a along the axial direction at positions across the flat connecting portion 12c in the width direction.

Further, the resin housing 22 includes a pair of terminal covering wall portions 22c at positions across the terminal 21 in the width direction, and an internal between the inner surfaces of the pair of terminal covering wall portions 22c is set to be smaller than a diameter of the insulation coating 12b. That is, the resin housing 22 includes the pair of narrowed wall portions 22b and the pair of terminal covering wall portions 22c to reduce a useless space inside according to the diameter of the insulation coating 12b, a width of the flat connecting portion 12c and a width of the terminal 21.

### (Configuration of Metal Shell 23)

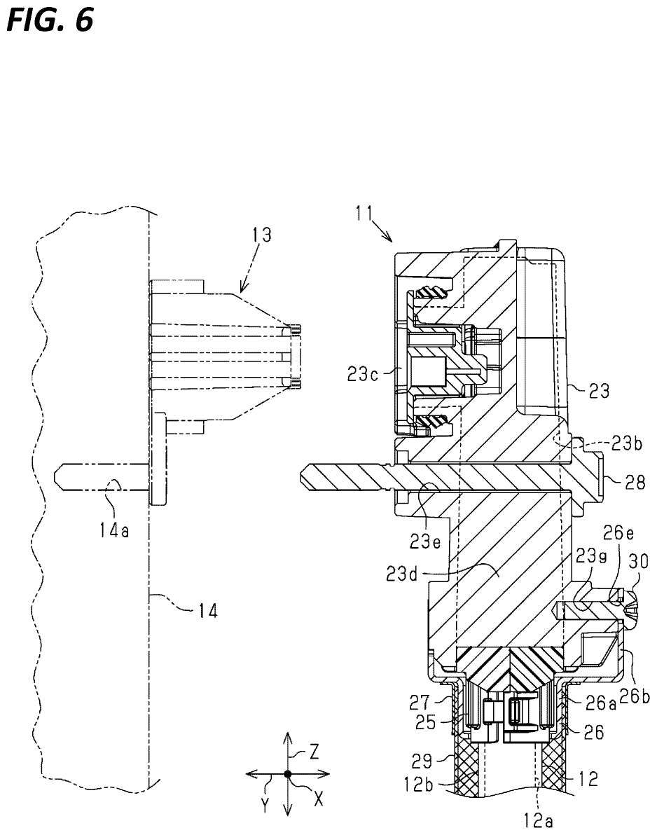

As shown in FIG. 5, the metal shell 23 is formed to cover the resin housings 22. The metal shell 23 includes housing accommodating portions 23b extending in the direction toward the tip along the axial direction while including openings 23a in a base end part in the axial direction. The housing accommodating portion 23b is formed into a shape capable of accommodating the resin housing 22 substantially without any gap according to the shape of the resin housing 22. Two housing accommodating portions 23b are provided side by side in the width direction according to the number of the resin housings 22. Further, as shown in FIG. 6, the metal shell 23 includes a communication hole 23c open forward to communicate with tip sides of the housing accommodating portions 23b.

Further, as shown in FIG. 5, the metal shell 23 includes a partition wall 23d between the two housing accommodating portions 23b. The partition wall 23d is formed in the entire metal shell 23 in the axial direction. As shown in FIGS. 5 and 6, a fixing hole 23e penetrating in the front-rear direction is provided in the partition wall 23d in the metal shell 23. That is, the fixing hole 23e is provided between the plurality of wires 12 in the width direction, in which direction the plurality of wires 12 are provided side by side. In other words, the fixing hole 23e is provided at a position in the width direction between a position in the width direction where one wire 12 is disposed and a position in the width direction where the other wire 12 is disposed. As shown in FIG. 5, the fixing hole 23e is provided between the flat connecting portions 12c. In other words, the fixing hole 23e is provided at a position in the axial direction overlapping positions in the axial direction where the flat connecting portions 12c are provided. As shown in FIGS. 1 and 6, the metal shell 23 can be fixed to the metal case 14 by a bolt 28 passed through the fixing hole 23e and threadably engaged with an internal thread 14a of the metal case 14.

### (Configuration of Rubber Plug 24)

As shown in FIG. 5, the rubber plug 24 is formed to prevent the intrusion of a liquid into the connector 11 along the insulation coating 12b. In particular, the rubber plug 24 is formed into a tubular shape to be interposed between the insulation coating 12b and the opening 23a of the metal shell 23. The rubber plug 24 prevents the intrusion of the liquid into the connector 11 by being held in close contact with the insulation coating 12b and the opening 23a of the metal shell 23.

### (Configuration of Retainer 25)

As shown in FIGS. 2, 3 and 5, the retainer 25 is configured to prevent the detachment of the rubber plugs 24 by being locked to the metal shell 23. In particular, the retainer 25 is made of resin. The retainer 25 includes two contacting tube portions 25a projecting outward from the metal shell 23 and configured to contact the outer peripheries of the insulation coatings 12b.

Further, as shown in FIGS. 2 and 3, the retainer 25 includes a flange portion 25b extending outward while coupling end parts in the axial direction of the two contacting tube portions 25a and locking pieces 25c bent and extending from the flange portion 25b. Four locking pieces 25c are provided. The locking pieces 25c are respectively provided at positions in front of and behind the contacting tube portions 25a. The locking pieces 25c lock the retainer 25 to the metal shell 23 by being engaged with locking projections 23f provided on the outer surface of the metal shell 23. The flange portion 25b is arranged to close the openings 23a, whereby the retainer 25 prevents the rubber plugs 24 from coming out from the openings 23a. Note that the retainer 25 of this embodiment is composed of two components assembled along the front-rear direction to sandwich the insulation coatings 12b in the front-rear direction.

### (Configuration of Metal Bracket 26)

As shown in FIG. 6, the metal bracket 26 is connected to a collective shield member 29 serving as a shield member for covering the insulation coatings 12b and the metal shell 23. In particular, the shield member of this embodiment is the tubular collective shield member 29 for collectively covering the plurality of insulation coatings 12b. Further, the collective shield member 29 of this embodiment is a braided member formed by braiding electrically conductive strands made of copper alloy, aluminum alloy or the like into a tubular shape.

The metal bracket 26 includes a tube portion 26a, to which the entire periphery of the collective shield member 29 is connected, and a fastening portion 26b extending from a part in a circumferential direction of the tube portion 26a. As shown in FIG. 2, the tube portion 26a is formed into a shape capable of covering the two contacting tube portions 25a. In particular, the tube portion 26a includes a pair of parallel portions 26c and a pair of arcuate portions 26d having a semicircular shape and linking the pair of parallel portions 26c. By crimping and fixing the crimp ring 27 from outside with the collective shield member 29 arranged on the outer peripheral surface of the tube portion 26a, the collective shield member 29 is connected to the tube portion 26a.

The fastening portion 26b extends rearward from an end part of one parallel portion 26c and is bent and extends in the axial direction. The fastening portion 26b is provided with a fastening hole 26e. Further, the metal shell 23 includes an internally threaded portion 23g. The internally threaded portion 23g is provided in an outer surface behind the metal shell 23. As shown in FIG. 6, the metal bracket 26 is fixed to the metal shell 23 by a fastening screw 30 passed through the fastening hole 26e and threadably engaged with the internally threaded portion 23g.

Further, as shown in FIGS. 3, 7 and 8, the metal bracket 26 includes a slit 26f serving as a circumferentially engaging portion on a side opposite to the fastening portion 26b in the circumferential direction of the tube portion 26a. The metal shell 23 includes a rib 23h serving as a circumferentially engaged portion to be engaged with the slit 26f. In particular, the metal bracket 26 includes an extending portion 26g extending along the axial direction from the tube portion 26a. The slit 26f extends along the axial direction of the tube portion 26a from a center in the width direction of the tip of the extending portion 26g. Further, the rib 23h is formed to project from the metal shell 23, extend along the axial direction of the tube portion 26a and be fit into the slit 26f.

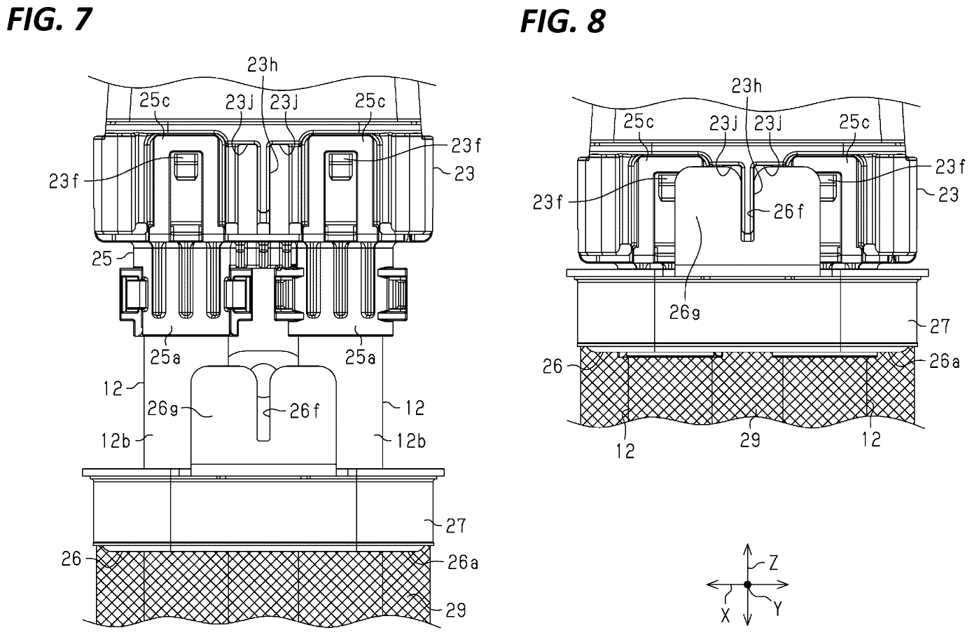

Further, as shown in FIGS. 7 and 8, the metal shell 23 includes a positioning wall 23j to be butted against the tip of the extending portion 26g of the metal bracket 26. The positioning wall 23j extends toward both sides in the width direction from the rib 23h while being connected to the rib 23h. The positioning wall 23j is set to butt against the tip in the axial direction of the extending portion 26g with the rib 23h fit in the slit 26f.

Next, functions of the connector 11 configured as described above are described.

The collective shield member 29 is electrically connected to the metal case 14 via the metal bracket 26, the metal shell 23 and the bolt 28 and is grounded. Thus, the emission of electromagnetic noise from the wires 12 and the terminals 21 covered by the collective shield member 29, the metal bracket 26 and the metal shell 23 is satisfactorily suppressed. Further, the openings 23a of the metal shell 23 are filled by the rubber plugs 24. Thus, the intrusion of a liquid into the connector 11 along the insulation coatings 12b is prevented.

Next, effects of the above embodiment are described below.

(1) Since the fastening screw 30 is provided which fixes the metal bracket 26 to the metal shell 23 by being passed through the fastening hole 26e of the metal bracket 26 and threadably engaged with the internally threaded portion 23g of the metal shell 23, the configuration can be simplified, for example, as compared to a fastening configuration by a nut and a bolt. That is, in the configuration for fastening the metal bracket and the metal shell by the nut and the bolt while holding the nut in the resin housing, the number of components is increased by the nut and a structure for holding the nut is complicated. However, this can be avoided.

(2) The shield member for covering the insulation coatings 12b is the tubular collective shield member 29 for collectively covering the plurality of insulation coatings 12b, and the metal bracket 26 includes the tube portion 26b, to which the collective shield member 29 is connected over the entire periphery. Thus, the collective shield member 29 can be satisfactorily connected to the metal bracket 26.

(3) The metal bracket 26 includes the slit 26f serving as the circumferentially engaging portion engageable in the circumferential direction of the tube portion 26a on the side opposite to the fastening portion 26b in the circumferential direction, and the metal shell 23 includes the rib 23h serving as the circumferentially engaged portion to be engaged with the slit 26f. Thus, the metal bracket 26 is satisfactorily suppressed from rattling with respect to the metal shell 23. That is, since the tube portion 26a is suppressed from rattling in the circumferential direction with respect to the metal shell 23 at two positions on sides opposite to each other in the circumferential direction, the rattling of the metal bracket 26 with respect to the metal shell 23 is satisfactorily suppressed.

(4) The circumferentially engaging portion is the slit 26f extending along the axial direction of the tube portion 26 a from the tip of the extending portion 26g, and the circumferentially engaged portion is the rib 23h projecting from the metal shell 23 and extending along the axial direction of the tube portion 26a. Thus, the rattling of the metal bracket 26 with respect to the metal shell 23 is strongly suppressed. That is, since the slit 26f and the rib 23 h are engaged in a long range along the axial direction of the tube portion 26a, the rattling of the metal bracket 26 with respect to the metal shell 23 is strongly suppressed.

(5) Since the metal shell 23 includes the positioning wall 23j to be butted against the tip of the extending portion 26g, the metal bracket 26 can be satisfactorily positioned along the axial direction of the tube portion 26a.

(6) The retainer 25 for preventing the detachment of the rubber plugs 24 includes the contacting tube portions 25a projecting outward from the metal shell 23 and configured to contact the outer peripheries of the insulation coatings 12b. Thus, for example, even if the wire 12 vibrates outside the connector 11, the transmission of that vibration to the terminal 21 inside the connector 11 is suppressed. Thus, the rubbing and the like of the terminal 21 are suppressed. Since the tube portion 26a of the metal bracket 26 is arranged to cover the contacting tube portions 25a, good shielding is provided also at the contacting tube portions 25.

This embodiment can be modified and carried out as follows. This embodiment and the following modifications can be combined with each other and carried out without technically contradicting.
Although the metal bracket 26 includes the tube portion 26a, to which the collective shield member 29 is connected over the entire periphery, in the above embodiment, there is no limitation to this and a change may be made to a metal bracket, which does not include the tube portion 26a and to which the collective shield member 29 is connected.
Although the shield member for covering the insulation coatings 12b is the tubular collective shield member 29 for collectively covering the plurality of insulation coatings 12b in the above embodiment, there is no limitation to this and a change may be made to shield members for respectively covering the insulation coatings 12b. Note that, in this case, a connection structure of the metal bracket 26 and the shield members needs to be changed, such as by changing the shape of the metal bracket 26.
Although the metal bracket 26 includes the slit 26f serving as the circumferentially engaging portion engageable in the circumferential direction of the tube portion 26a on the side opposite to the fastening portion 26b in the circumferential direction in the above embodiment, there is no limitation to this and, for example, a change may be made to a circumferentially engaging portion other than the slit 26f.

Further, for example, the metal bracket 26 may include a circumferentially engaging portion engageable in the circumferential direction of the tube portion 26a in a place other than the side opposite to the fastening portion 26b in the circumferential direction. Further, for example, the metal bracket 26 may include circumferentially engaging portions engageable in the circumferential direction of the tube portion 26a at a plurality of positions in the circumferential direction.

Further, for example, the metal bracket 26 may include no circumferentially engaging portion. Note that, in these cases, the rib 23h serving as the circumferentially engaged portion in the metal shell 23 may be changed according to the circumferentially engaging portion(s).
Although the metal shell 23 includes the positioning wall 23j to be butted against the tip of the extending portion 26g in the above embodiment, there is no limitation to this and, for example, the positioning wall 23j may not be provided.
Although the tube portion 26a of the metal bracket 26 is arranged to cover the contacting tube portions 25a of the retainer 25 in the above embodiment, there is no limitation to this and, for example, the tube portion 26a may be arranged not to cover the contacting tube portions 25a.
Although the retainer 25 for preventing the detachment of the rubber plugs 24 includes the contacting tube portions 25a projecting outward from the metal shell 23 and configured to contact the outer peripheries of the insulation coatings 12b in the above embodiment, there is no limitation to this and, for example, the contacting tube portions 25a may not be provided. For example, the retainer 25 may be accommodated into the metal shell 23.
Although the rubber plug 24 is interposed between the insulation coating 12b and the metal shell 23 in the above embodiment, there is no limitation to this and, for example, a rubber plug may be interposed between an insulation coating and a resin housing.
Although the fixing hole 23e is provided between the plurality of wires 12 in the width direction in the above embodiment, there is no limitation to this and the fixing hole 23e may be provided at another position. For example, the fixing hole 23h may be provided in a fixing portion projecting outward in the axial direction and/or the width direction of the metal shell 23.
Although the core wire 12a includes the flat connecting portion 12c and is so arranged that the thickness direction of the flat connecting portion 12c is along the width direction of the connector 11 in the above embodiment, there is no limitation to this and a change may be made to another configuration. For example, the core wire 12a may not include the flat connecting portion 12c.
Although the fixing hole 23e is provided between the flat connecting portions 12c in the above embodiment, there is no limitation to this and the fixing hole 23e may be provided at a position deviated in the axial direction from the position between the flat connecting portions 12c. For example, the fixing hole 23e may be provided at a position deviated in the axial direction from the position between the flat connecting portions 12c and between the terminals 21. Further, for example, a plurality of fixing holes 23a may be provided at the same position in the width direction of the connector 11, but deviated in the axial direction.
Although the terminal 21 includes the plate-like terminal connecting portion 21b and is fixed to the flat connecting portion 12c by welding in the above embodiment, there is no limitation to this and a change may be made to another configuration. For example, the terminal 21 may not include the plate-like terminal connecting portion 21b and may be fixed to the core wire 12a by crimping or the like.
Although the resin housing 22 includes the pair of narrowed wall portions 22b having the interval in the width direction gradually reduced at the positions across the plate-like flat connecting portion 12c in the above embodiment, there is no limitation to this and the resin housing 22 may not include the pair of narrowed wall portions 22b. For example, the resin housing 22 may include a pair of wall portions having a constant interval in the width direction at positions across the flat connecting portion 12c.
Although the interval between the inner surfaces of the pair of terminal covering wall portions 22c provided at the positions across the terminal 21 in the width direction is smaller than the diameter of the insulation coating 12b in the above embodiment, there is no limitation to this and this interval may be larger than the diameter of the insulation coating 12b. That is, the interval between the inner surfaces of the pair of terminal covering wall portions 22c may be sized to be able to accommodate also the part covered by the insulation coating 12b.
Although the connector 11 is fixed to the end parts of the two wires 12 in the above embodiment, there is no limitation to this and the connector 11 may be fixed to end parts of three or more wires. Note that, in this case, the numbers of the terminals 21, the resin housings 22 and the rubber plugs 24 need to be changed according to the number of the wires 12. Further, in this case, the fixing hole 23e may be provided between each adjacent pair of the wires 12 or may be provided only at one position in the width direction, in which the plurality of wires 12 are arranged.
Although the external ground member is the metal case 14 in the above embodiment, there is no limitation to this and a change may be made to another external ground member. For example, the metal case 14 may be a vehicle body.
In the above embodiment, each resin housing 22 may be an elongated tubular member as shown in FIG. 5 and may be provided to cover the end part of the insulation coating 12b of one wire 12, the core wire 12a exposed from the end part of the insulation coating 12b and the terminal 21 connected to the core wire 12a.
In the above embodiment, the metal shell 23 may be configured to entirely accommodate the plurality of resin housings 22 as shown in FIG. 5. The metal shell 23 may include the plurality of openings 23a respectively communicating with the plurality of housing accommodating portions 23b in the axial direction and each opening 23a may be configured to accommodate the rubber plug 24.
As shown in FIG. 6, the internally threaded portion 23g of the metal shell 23 may be located on a side opposite to the communication hole 23c of the metal shell 23 in the circumferential direction and may be provided between the plurality of wires 12 to be arranged side by side with the fixing hole 23e of the metal shell 23 along the axial direction.
As in the shown embodiment, the terminal 21 may be an elongated member extending along the third axis Z, i.e. in the axial direction, inside the connector 11. As in the shown embodiment, the terminal 21 may be connected to the wire 12 coaxially with the wire 12 on the tip of the wire 12.
Since the wire 12 is pulled out along the third axis Z, i.e. in the axial direction, from the connector 11 in the shown embodiment, the third axis Z, i.e. the axial direction, may be referred to as a wire pull-out direction from the connector. In the shown embodiment, the second axis Y, i.e. the front-rear direction, may be referred to as an attachment direction of the connector 11 to the mating connector 13 and/or a fastening direction of the bolt 28 to the mating connector 13. As in the shown embodiment, the pull-out direction of the wire 12 from the connector 11 and the attachment direction of the connector 11 to the mating connector 13 may be orthogonal. The connector 11 of the shown embodiment may be referred to as an L-shaped connector for vehicle and/or a flat L-shaped connector for vehicle.

### LIST OF REFERENCE NUMERALS

11 connector
12 wire
12a core wire
12b insulation coating
12c flat connecting portion
13 mating connector
13a mating terminal
14 metal case
14a internal thread
21 terminal
21a terminal fitting portion
21b terminal connecting portion
22 resin housing
22a terminal opening
22b narrowed wall portion
22c terminal covering wall portion
23 metal shell
23a opening
23b housing accommodating portion
23c communication hole
23d partition wall
23e fixing hole
23f locking projection
23g internally threaded portion
23h rib
23j positioning wall
24 rubber plug
25 retainer
25a contacting tube portion
25b flange portion
25c locking piece
26 metal bracket
26a tube portion
26b fastening portion
26c parallel portion
26d arcuate portion
26e fastening hole
26f slit
26g extending portion
27 ring
28 bolt
29 collective shield member
30 fastening screw
X first axis
Y second axis
Z third axis

1. A connector to be fixed to a plurality of wires each including a core wire and an insulation coating, comprising:
terminals to be connected to the core wires;
resin housings for covering the core wires and the terminals;
a metal shell for covering the resin housings, the metal shell being fixed to an external ground member; and
a metal bracket, a shield member for covering the insulation coatings being connected to the metal bracket, the metal bracket being connected to the metal shell,
the metal shell including an internally threaded portion,
the metal bracket including a fastening hole, and
the connector comprising a fastening screw for fixing the metal bracket to the metal shell by being passed through the fastening hole and threadably engaged with the internally threaded portion.

2. The connector of claim 1, wherein:
the shield member is a tubular collective shield member for collectively covering a plurality of the insulation coatings, and
the metal bracket includes a tube portion, the collective shield member being connected to the tube portion over an entire periphery, and a fastening portion extending from a part in a circumferential direction of the tube portion and provided with the fastening hole.

3. The connector of claim 2, wherein:
the metal bracket includes a circumferentially engaging portion engageable in the circumferential direction of the tube portion on a side opposite to the fastening portion in the circumferential direction, and
the metal shell includes a circumferentially engaged portion to be engaged with the circumferentially engaging portion.

4. The connector of claim 3, wherein:
the metal bracket includes an extending portion extending along an axial direction from the tube portion,
the circumferentially engaging portion is a slit extending along the axial direction of the tube portion from a tip of the extending portion, and
the circumferentially engaged portion is a rib projecting from the metal shell, extending along the axial direction of the tube portion and to be fit into the slit.

5. The connector of claim 4, wherein the metal shell includes a positioning wall to be butted against the tip of the extending portion.

6. The connector of claim 2, comprising:
a rubber plug for preventing liquid intrusion along the insulation coatings, and
a retainer for preventing detachment of the rubber plug by being locked to the metal shell, wherein:
the retainer includes contacting tube portions projecting outward from the metal shell and configured to contact outer peripheries of the insulation coatings, and
the tube portion is arranged to cover the contacting tube portions.
